(19) United States
(12) Patent Application Publication
(10) Pub. No.: US 2006/0194093 A1
(43) Pub. Date: Aug. 31, 2006

(54) Fuel cell and fuel cell case

(75) Inventors: Kenji Kibune, Ora-Gun (JP); Takeshi Minamiura, Ora-Gun (JP); Shinichiro Imura, Ora-Gun (JP); Ryoko Kubo, Ora-Gun (JP); Hiroki Kabumoto, Saitama-Shi (JP); Takashi Yasuo, Ashikaga-Shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/363,188

(22) Filed: Feb. 28, 2006

(30) Foreign Application Priority Data
Feb. 28, 2005 (JP) 2005-054195
Feb. 6, 2006 (JP) 2006-028990

(51) Int. Cl. H01M 8/04; H01M 8/10

(52) U.S. Cl. 429/34; 429/30

(57) ABSTRACT

A direct liquid fuel cell is provided, which can prevent a gas such as carbon dioxide generated by an anode of the fuel cell from adhering to an electrode. A DMFC that is a direct liquid fuel cell includes: an electrolyte membrane; an anode electrode provided on a surface of the electrolyte membrane; a cathode electrode provided on another surface of the electrolyte membrane; and a methanol fuel storage portion, provided to be adjacent to the anode electrode, for supplying a liquid fuel to the anode electrode. In the DMFC, the methanol fuel storage portion contains a solid particle.

### BACKGROUND OF THE INVENTION

1. Field of the Invention

The present invention relates to a direct liquid fuel cell to which a liquid fuel is directly supplied. In particular, the present invention relates to a direct liquid fuel cell and a fuel cell case that can prevent a gas such as carbon dioxide generated by an anode of the fuel cell from adhering to an electrode.

2. Description of the Related Art

A fuel cell is a device that generates an electric energy from hydrogen and oxygen, and can have high power generation efficiency. The fuel cell has the following main features. First, high power generation efficiency can be expected even in small-scale power generation because power is directly generated without going through a heat energy process or a kinetic energy process unlike a conventional power generation method. Second, the fuel cell is better for an environment because the amount of emission of nitrogen compounds and the like is small and a noise and a vibration generated by the fuel cell are low. That is, the fuel cell can effectively use a chemical energy of a fuel and has characteristics that are good for the environment. Thus, the fuel cell is expected to be an energy supply system that will be a major player in the 21st century, and attracts attention as a new promising power generation system that can be used in various applications from large-scale power generation to small-scale power generation, e.g., for use in space, a car, and a mobile device. In order to put the fuel cell in practical use, development of techniques related to the fuel cell begins in earnest.

Among various types of fuel cells, a proton-exchange membrane fuel cell has a feature that it has a lower operating temperature and a higher power density as compared with other types of fuel cells. In particular, a direct methanol fuel cell (hereinafter, simply referred to as DMFC) that is one form of the proton-exchange membrane fuel cell attracts attention in recent years. In the DMFC, methanol aqueous solution as a fuel is directly supplied to an anode without being reformed and power is generated by electrochemical reaction of methanol aqueous solution and oxygen. This electrochemical reaction discharges carbon dioxide from the anode and water from a cathode as reaction products. Methanol aqueous solution has a higher energy per unit volume, is more suitable for storage, and has a lower risk of explosion or the like, as compared with hydrogen. Therefore, it is expected that methanol aqueous solution be used in a power source for a vehicle, a mobile device (e.g., a cell-phone, a laptop PC, a PDA, an MP3 player, a digital camera, or an electronic dictionary (book)), or the like.

Carbon dioxide is generated in the anode of the DMFC, as described above. The thus generated carbon dioxide has a problem that, when being contained as carbonate ions or a gas in the methanol aqueous solution as the fuel, the carbon dioxide blocks supply of the fuel to the anode electrode, for example. Thus, various measures are implemented (for example, see Japanese Patent Laid-Open No. 2004-039307).

A conventional method for removing carbon dioxide can remove carbon dioxide contained in methanol aqueous solution as the fuel. However, it is difficult to remove carbon dioxide in the form of gas bubbles that adhere to the anode electrode and block a fine fuel supply path. Unless carbon dioxide blocking the fuel supply path in the anode electrode is removed, the fuel supply path cannot be secured sufficiently. Thus, power generation efficiency of the DMFC is lowered. In particular, that tendency is pronounced in a so-called passive type DMFC that does not include a unit for forcibly supplying the fuel to the anode electrode, e.g., a pump.

### SUMMARY OF THE INVENTION

Therefore, it is an object of the present invention to provide a direct liquid fuel cell such as a DMFC and a fuel cell case, which can prevent a gas such as carbon dioxide generated by an anode of the fuel cell from adhering to an electrode.

In order to achieve the above object, according to an aspect of the present invention, a direct liquid fuel cell comprises: an electrolyte membrane; an anode electrode provided on a surface of the electrolyte membrane; a cathode electrode provided on another surface of the electrolyte membrane; and a liquid fuel storage portion provided to be adjacent to the anode electrode, the storage portion supplying a liquid fuel to the anode electrode, wherein the liquid fuel storage portion contains a solid particle. Due to this, it is possible to prevent a gas such as carbon dioxide generated by the anode from adhering to the electrode. Note that the solid particle shall refer to a particle that is in a solid state in an ordinary temperature range of from about −10° C. to about +50° C. in which the fuel cell is usually used, i.e., a particle of a material at least having a melting point of 100° C. or higher.

In the fuel cell of the above aspect, the solid particle may be formed from a material that is hardly soluble with respect to the liquid fuel. In this case, not only an advantage of the above aspect but also an advantage that the solid particle can prevent adhesion of the gas to the electrode without being dissolved in the liquid fuel can be achieved. Moreover, in the case where carbon dioxide is dissolved in the liquid fuel as carbonate ions, the liquid fuel is weakly acidic. Therefore, it is more desirable that the solid particle be formed from a material having a certain acid resistance.

In the fuel cell of the above aspect, the solid particle may contain a plurality of types of solid particles having different shapes or a plurality of types of solid particles having different densities. In this case, in addition to the aforementioned advantages, the following advantages can be achieved. Adhesion of the gas to the electrode can be prevented more effectively. Moreover, when a solid particle having a lower density than the liquid fuel is contained, adhesion of the gas to the electrode can be prevented even if the fuel cell is arranged to look to any direction or is moved.

In the fuel cell of the above aspect, a surface in which the gas generated by the anode electrode stays may not be horizontal. Due to this, the gas can move to a predetermined direction because the surface in which the gas stays is not horizontal. Thus, the gas can be discharged from the liquid fuel storage portion.

According to another aspect of the present invention, a fuel cell case is provided. The fuel cell case comprises: a direct liquid fuel cell including an electrolyte membrane, an anode electrode provided on a surface of the electrolyte membrane, a cathode electrode provided on another surface of the electrolyte membrane, and a liquid fuel storage portion that is provided to be adjacent to the anode electrode and supplies a liquid fuel to the anode electrode; a fuel keeping portion which stores a liquid fuel with which the liquid fuel storage portion is refilled; a housing which accommodates the fuel cell and the fuel keeping portion; and at least one elastic member which connects at least one outer surface of the fuel cell to an inner surface of the housing that is opposed to the outer surface of the fuel cell.

Due to this, in the case where an external force is applied to the fuel cell case, it is possible to allow oscillation of the fuel cell accommodated in the fuel cell case to last. As a result, a flow of methanol solution stored in the liquid fuel storage portion lasts for a long period of time and adhesion of a bubble to the electrode can be suppressed.

In the fuel cell case of the above aspect, at least a pair of outer surfaces of the fuel cell may be connected to inner surfaces of the housing by a plurality of the elastic members, and at least two of the plurality of elastic members may have natural frequencies different from each other. Moreover, in the fuel cell case of the above aspect, a plurality of outer surfaces of the fuel cell may be connected to inner surfaces of the housing that are opposed to the outer surfaces of the fuel cell by elastic members, respectively, and elastic members for at least two of a plurality of pairs of an outer surface of the fuel cell and an inner surface of the housing may have natural frequencies different from each other.

Due to this, in the case where a periodic external force is applied to the fuel cell case, it is highly likely that any of the elastic members resonates with the periodic external force. Therefore, the oscillation of the DMFC can be made to last for a long period of time.

In the fuel cell case of the above aspect, the fuel keeping portion may be attached to the fuel cell. In this case, piping connecting the fuel keeping portion to the fuel storage portion is not required. Thus, leak of methanol solution caused by damage of the piping connecting the fuel keeping portion to the fuel storage portion because of the oscillation of the fuel cell can be eliminated.

In the fuel cell case of the above aspect, the fuel keeping portion may be formed by sealing a part of an inside of the housing, and the fuel cell case may further include a fuel replenishment member which connects the fuel keeping portion and the liquid fuel storage portion to each other, the fuel replenishment member sucking the liquid fuel stored in the fuel keeping portion, and supplying the sucked liquid fuel to the liquid fuel storage portion.

Due to this, it is possible to gradually replenish methanol solution from the fuel keeping portion formed in the inner space of the fuel cell case to the liquid fuel storage portion.

In the fuel cell case of the above aspect, the inner surface of the housing to which the elastic member is connected may be a surface of a member forming the fuel keeping portion, and the fuel replenishment member may be assembled with the elastic member.

Due to this, a load applied to the fuel replenishment member and the elastic member is distributed and therefore strength of connection between the fuel cell case and the fuel cell can be enhanced.

The fuel cell case of the above aspect may further comprise a charging portion which charges with power generated by the fuel cell and a charging circuit which supplies the power from the fuel cell to the charging portion.

Due to this, charging can be performed by using the power generated by the fuel cell in which adhesion of a bubble to the electrode is suppressed.

The fuel cell case of the above aspect may further comprise a base portion on which the housing and the charging portion are mounted, openings may be provided in a cathode-side surface of the housing that is opposed to a cathode side of the fuel cell and in an anode-side surface of the housing that is opposed to an anode side of the fuel cell, and the charging portion may be provided on the base portion to be away from the anode-side surface.

Due to this, an air can be taken into the cathode side of the fuel cell from the outside of the fuel cell case. Moreover, carbon dioxide generated in electrochemical reaction can be discharged from the anode side of the fuel cell to the outside of the fuel cell case.

In the fuel cell case of the above aspect, at least one of the elastic members may be a conductor which electrically connects the fuel cell to the charging circuit.

Due to this, the fuel cell and the charging circuit can be electrically connected to each other without increasing the number of parts. Thus, a manufacturing cost of the fuel cell case can be reduced.

In the fuel cell case of the above aspect, at least one of the elastic members may be a coil spring and the conductor which electrically connects the fuel cell to the charging circuit may be arranged inside a coil of the coil spring.

Due to this, the elastic member does not strike against the conductor even when the elastic member vibrates or rolls. Thus, it is possible to suppress occurrence of damage in the conductor and the elastic member and ensure a long operating life of the fuel cell case.

The fuel cell case of the above aspect may further comprise an opening and closing portion capable of opening and closing an opening provided in the anode-side surface and/or an opening provided on the cathode-side surface.

Due to this, entering of an air into the fuel cell case can be suppressed while the fuel cell is not used. Thus, electrochemical reaction in the fuel cell can be stopped rapidly.

In the fuel cell case of the above aspect, the liquid storage portion may contain a solid particle. In this case, the solid particle may be formed from a material that is hardly soluble with respect to the liquid fuel. Moreover, the solid particle may contain a plurality of types of solid particles having different shapes. In addition, the solid particle may contain a plurality of types of solid particles having different densities.

Due to this, the effect of removing the bubble can be achieved in a synergistic manner. Thus, the bubble adhering to the anode electrode can be removed more surely.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an exploded perspective view showing the basic structure of a DMFC used in respective embodiments of the present invention;

FIG. 2 is a cross-sectional view of a DMFC system according to a first embodiment of the present invention;

FIG. 3 is a cross-sectional view of a DMFC system according to a second embodiment of the present invention;

FIG. 4 is a perspective view of a fuel cell case according to a third embodiment of the present invention;

FIG. 5 is a cross-sectional view of the fuel cell case, taken along the line A-A′ in FIG. 4;

FIG. 6 is a cross-sectional view of the fuel cell case, taken along the line B-B′ in FIG. 4;

FIG. 7 is a cross-sectional view showing the structure of a fuel cell case according to a fourth embodiment of the present invention;

FIG. 8 shows the structure of a fuel replenishment member and an elastic member used in the fourth embodiment;

FIG. 9 is a perspective view showing the structure of a fuel cell case according to a fifth embodiment of the present invention;

FIG. 10 is a cross-sectional view of the fuel cell case, taken along the line C-C′ in FIG. 9;

FIG. 11 is a cross-sectional view of the fuel cell case, taken along the line D-D′ in FIG. 9;

FIG. 12 is a perspective view of a shutter used in the fifth embodiment;

FIG. 13 shows another method for connecting an anode and a cathode to a charge circuit in the fuel cell case of the fifth embodiment; and

FIG. 14 is a perspective view of a shutter according to a modified example.

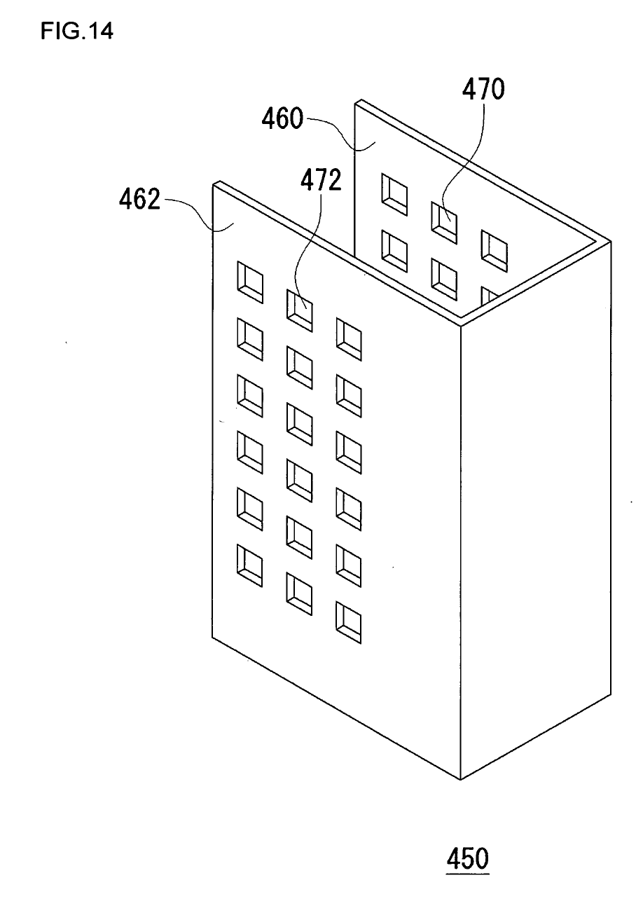

### DETAILED DESCRIPTION OF THE INVENTION

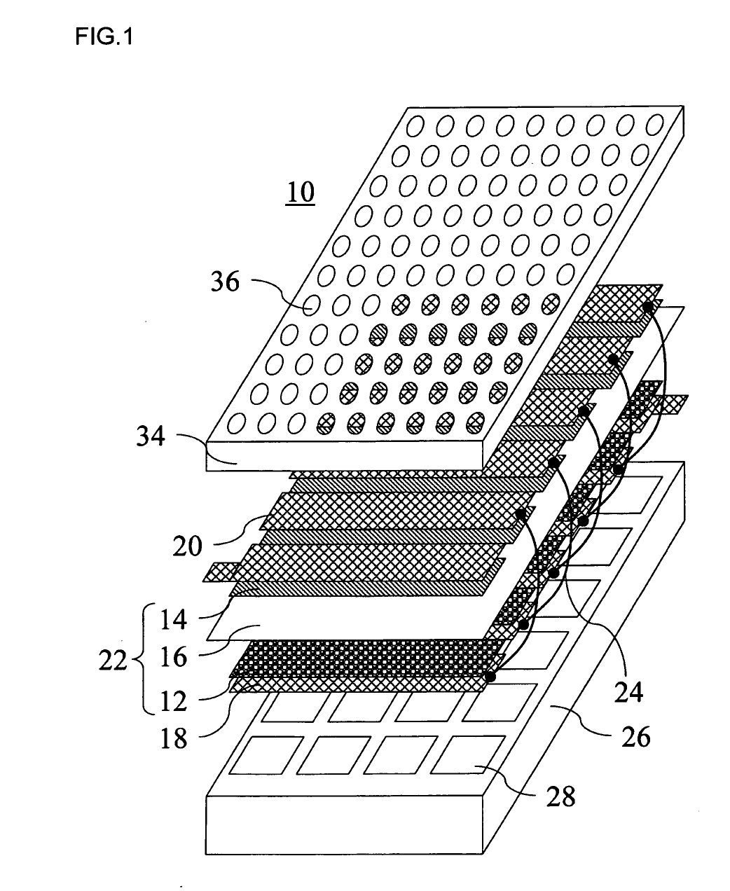

A basic structure of a DMFC 10 used in respective embodiments will be described in detail, with reference to FIG. 1.

The DMFC 10 includes: an anode electrode 12 to which methanol aqueous solution or pure methanol (hereinafter, simply referred to as “methanol fuel”) is supplied by a capillary action; a cathode electrode 14 to which an air is supplied; and an electrolyte membrane 16 sandwiched between the anode electrode 12 and the cathode electrode 14. The DMFC 10 generates power by electrochemical reaction of methanol in the methanol fuel and oxygen in the air. An anode-side collector 18 and a cathode-side collector 20 are provided in each cell 22. A plurality of cells 22 can be connected in series by connecting the anode-side collectors 18 and the cathode-side collectors 20 by a wiring 24. A methanol fuel storage portion 26 for storing the methanol fuel to be supplied to the anode electrode 12 is provided below the anode electrode 12. The methanol fuel stored in the methanol fuel storage portion 26 is supplied to an anode catalyst layer 32 by the capillary action of an anode electrode base material 30 that forms the anode electrode 12 from a methanol fuel supply port 28 via the anode-side collector 18. On the other hand, an air is supplied to a cathode catalyst layer 38 through an air intake 36 provided in an upper part of a housing 34 by using a flow of the air naturally generated from the air intake 36. In this embodiment, the anode electrode 12 and the cathode electrode 14 are formed by forming the anode catalyst layer 32 and the cathode catalyst layer 38 on the anode electrode base material 30 and a cathode electrode base material 40, respectively. However, the structure of the electrodes is not limited thereto, as long as the electrodes include catalyst layers 32 and 38 that have catalyst functions of generating H⁺ from methanol and water from H⁺ and oxygen, respectively.

### First Embodiment

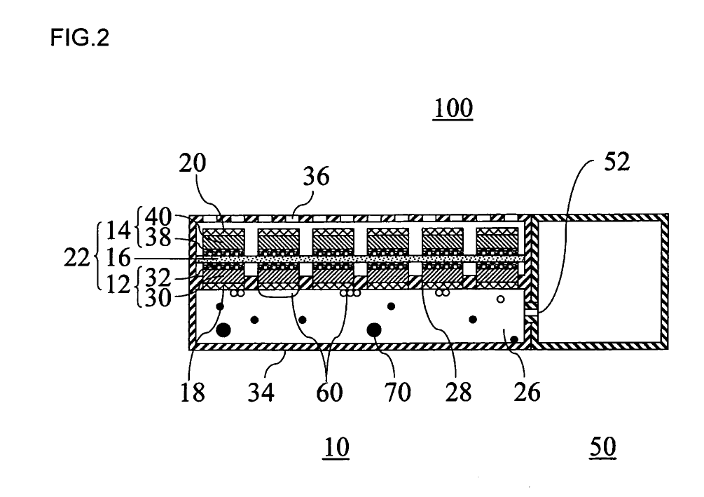

FIG. 2 is a cross-sectional view showing the basic structure of a DMFC system 100 in which a fuel cartridge 50 is attached to the DMFC 10. The fuel cartridge 50 is filled with methanol aqueous solution having a density greater than the methanol fuel or pure methanol. The fuel cartridge 50 has a fuel supply connection port 52 for refilling the methanol fuel storage portion 26 of the DMFC 10 with methanol. When the fuel supply connection port 52 is inserted into a corresponding portion of the DMFC 10, the DMFC 10 and the fuel cartridge 50 are connected to each other.

The methanol fuel in the methanol fuel storage portion 26 is soaked up by the capillary action of the anode-side base material 30 from the methanol fuel supply port 28 via the anode-side collector 18. Methanol is oxidized on the anode catalyst layer 32 (Chemical Formula (1)). Reaction on the anode catalyst layer 32 is represented as follows.

[Chemical Reaction Formula 1]
CH₃OH+H₂O+6H⁺+CO₂+6e (1)

Protons obtained by oxidation of methanol are diffused in the electrolyte membrane 16 and reach the cathode catalyst layer 38 of the cathode electrode 14. Electricity generated in the anode electrode 12 reaches the cathode-side collector 20 on the cathode electrode 14 side via the anode-side collector 18. On the other hand, oxygen in the air taken from the air intake 36 of the housing 34 reaches the cathode catalyst layer 38 of the cathode electrode 14 and then receives the protons and electrons obtained from the anode electrode 12 so as to cause oxygen reduction, thereby generating water (Chemical Formula (2)). Reaction on the cathode catalyst layer 38 is represented as follows.

[Chemical Reaction Formula 2]
3/2*O₂+6H⁺+6e⁻→3H₂O (2)

When the electricity taken from the cell 22 in the aforementioned manner is supplied to a mobile device, it is possible to directly drive the mobile device or charge a secondary battery or the like.

As represented by Chemical Formula 1, methanol oxidation in the anode catalyst layer 32 generates carbon dioxide. The thus generated carbon dioxide becomes a gas (bubble) 60 when a density thereof is equal to or larger than a certain density. The gas (bubble) 60 gets into pores in the anode-side collector 18 and the anode electrode base material 30 that are porous. In the anode electrode base material 30, a number of pores having an average diameter of several μm to several tens μm serve as fuel supply paths to the anode catalyst layer 32. Thus, when carbon dioxide in the form of a bubble 60 gets into those pores, the fuel supply paths are closed and the amount of methanol supplied to the anode catalyst layer 32 is reduced.

In order to prevent that, a particle (bead) 70 that is formed from a material having low reactivity with respect to methanol and a carbonate ion and has a diameter of 100 μm to several mm (this dimension is smaller than a height of the methanol fuel storage portion 26 by a length of clearance) is introduced into the methanol fuel storage portion 26. In the case where the bead 70 is slightly smaller than the height of the methanol fuel storage portion 26, about 1 to about 5 beads 70 are enough. In the case where the bead 70 has a dimension of several hundreds μm, about 10 to about 100 beads 70 are enough. In order to prevent wasting a volume of the methanol fuel storage portion 26, a total volume of the beads 70 is set to be less than 20% of the volume of the methanol fuel storage portion 26, more desirably, to about 0.001% to about 10%. Due to this, it is possible to remove the bubble 60 adhering to the anode-side collector 18 and the anode electrode base material 30 without wasting the volume of the methanol fuel storage portion 26.

It is preferable that the material for the bead 70 be a glass, a metal having high corrosion resistance such as gold, a fluorine contained resin, polymers such as PET (polyethylene terephthalate), PC (polycarbonate), PP (polypropylene), or PE (polyethylene). Moreover, in the case where a plurality of types of beads 70 that are different in material or dimension are introduced, when the DMFC 10 is moved, the beads 70 move in the methanol fuel in various ways in accordance with their material or dimension. Thus, it is possible to more efficiently remove the bubble 60 adhering to the anode-side collector 18 and the anode electrode base material 30.

### Second Embodiment

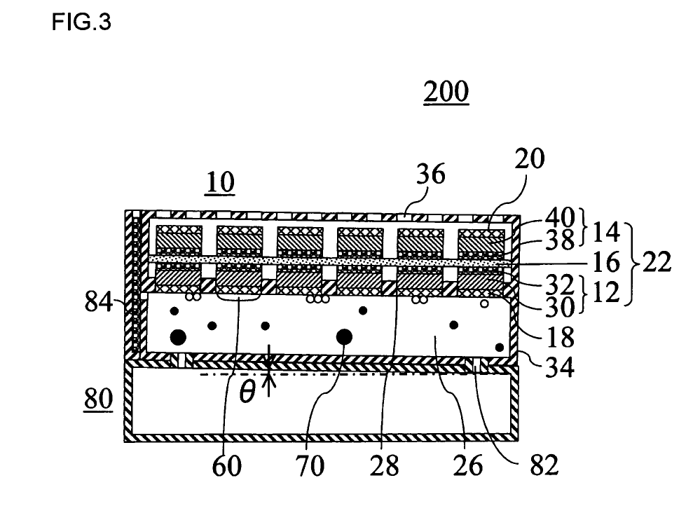

FIG. 3 is a cross-sectional view showing the basic structure of a DMFC system 200 in which a fuel cartridge 80 is attached to the DMFC 10. The fuel cartridge 80 is filled with methanol aqueous solution having a greater density than the methanol fuel or pure methanol, as in the first embodiment. In an upper part of the fuel cartridge 80, a fuel supply connection port 82 for refilling the methanol fuel storage portion 26 of the DMFC 10 with methanol is provided. When the fuel supply connection port 82 is inserted into a corresponding portion of the DMFC 10, the DMFC 10 and the fuel cartridge 80 are connected to each other.

One feature of the present embodiment is that an upper surface of the fuel cartridge 80 is inclined at an angle of θ (about 10 to about 100). Due to this structure, in addition to the advantage achieved by the first embodiment, an advantage can be achieved that the bubble 60 removed from the anode-side collector 18 and the anode electrode base material 30 by the bead 70 move toward an upper part in the methanol fuel storage portion 26 and is discharged to an adsorption portion 84. Thus, carbon dioxide can be efficiently discharged from the methanol fuel storage portion 26.

### Third Embodiment

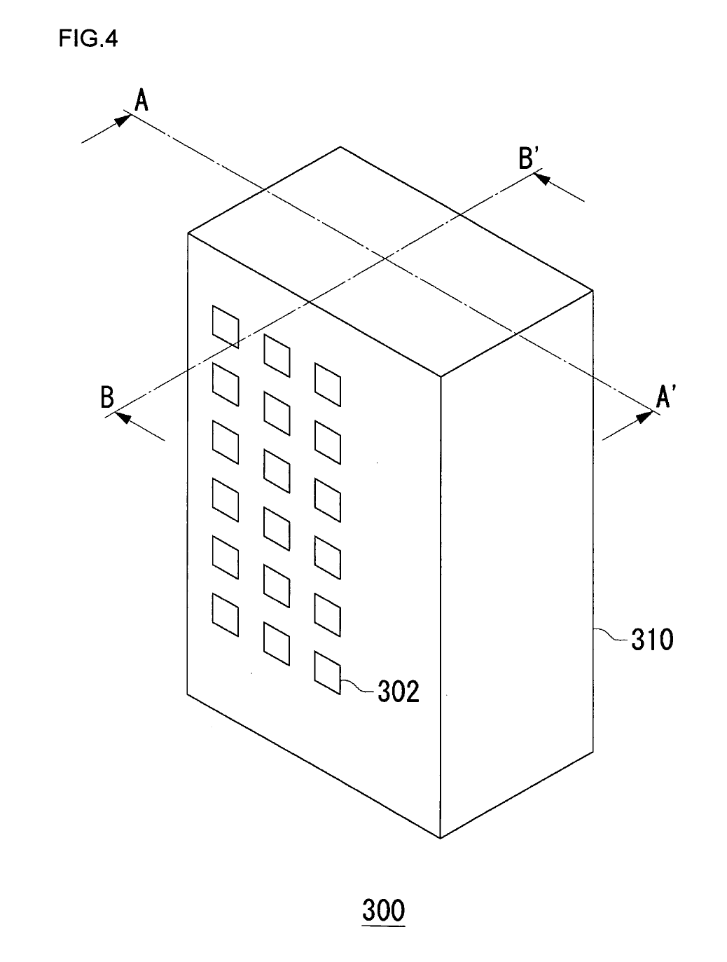

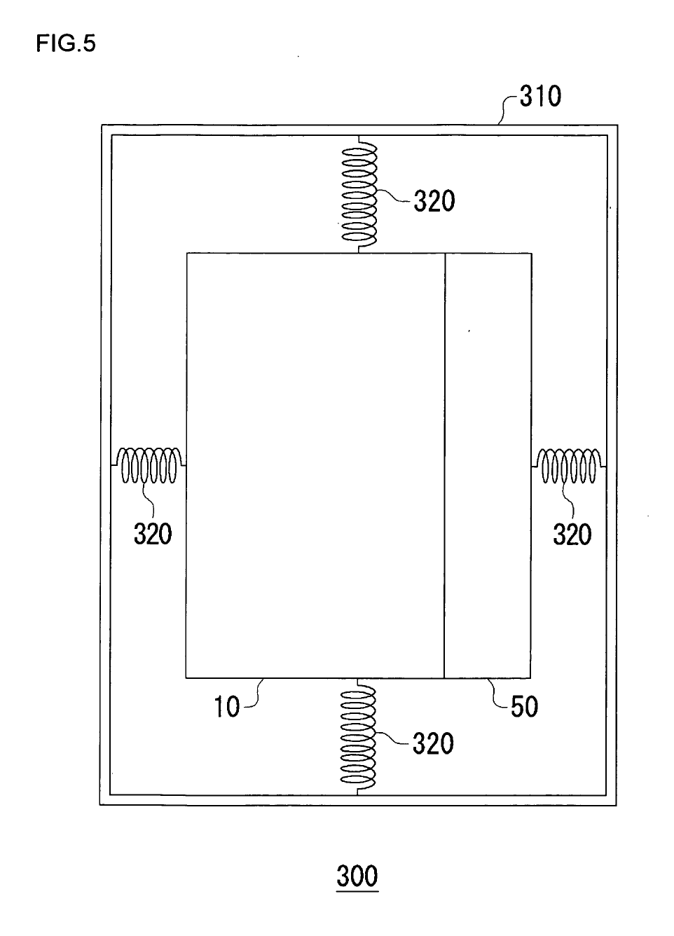

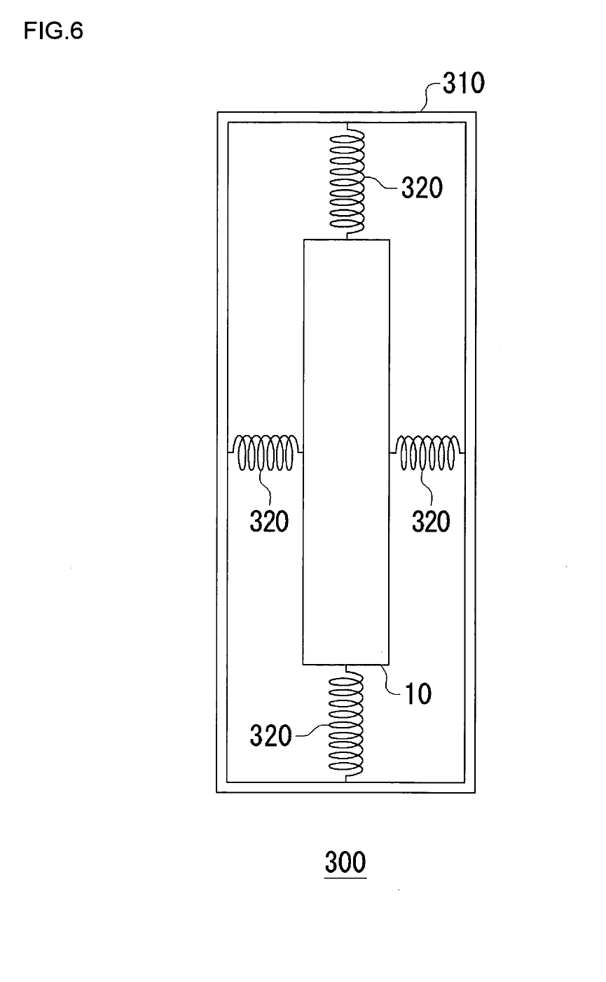

FIG. 4 is a perspective view of a fuel cell case 300 according to a third embodiment. FIGS. 5 and 6 are cross-sectional views of the fuel cell case 300, taken along the lines A-A′ and B-B′ in FIG. 4, respectively. The fuel cell case 300 of the third embodiment includes: the DMFC 10 of the first embodiment; the fuel cartridge 50 as a fuel keeping portion which stores methanol with which the DMFC 10 is to be refilled; a housing 310 which accommodates the DMFC 10 and the fuel cartridge 50; and a plurality of elastic members 320. The fuel cell case 300 has an opening 302 for taking an air in or discharging a gas such as carbon dioxide generated in the DMFC 10. The fuel cell case 300 is portable. For example, a user can take along the fuel cell case 300 as a power supply for a mobile information device by putting a strap attached to the fuel cell case 300 around a user's neck.

As shown in FIGS. 5 and 6, each outer surface of the DMFC 10 is connected to an inner surface of the housing 310 that is opposed to the outer surface of the DMFC 10 with the elastic member 320. An example of the elastic member 320 is a coil spring. In the following description, the elastic members 320 may be described as elastic members 320a and 320b in order to distinguish individual elastic members, for example.

Due to this structure, when an external force is applied to the fuel cell case 300 because of walking of a user who takes along the fuel cell case 300, for example, the elastic member 320 vibrates. In other words, when the external force is applied to the fuel cell case 300 once, the DMFC 10 in the fuel cell case 300 begins to oscillate and the oscillation lasts for a long period of time. As a result, a flow of methanol stored in the methanol fuel storage portion 26 that is a part of the DMFC 10 also lasts for a long period of time, thus causing difficulty in adhering of the bubbles 60 to the anode-side collector 18 and the anode electrode base material 30 (see FIG. 2). The flow of methanol in the methanol fuel storage portion 26 can last even after the oscillation of the DMFC 10 ends. Therefore, the effect of suppressing adhesion of the bubble 60 can last for a longer period of time.

In addition, since the bead 70 (see FIG. 2) is contained in the methanol fuel storage portion 26 in the present embodiment, the effect of removing the bubble can be obtained in a synergistic manner. As a result, it is possible to remove the bubble 60 adhering to the anode-side collector 18 and the anode electrode base material 30 more surely.

It is preferable that natural frequencies of the respective elastic members 320 be different from each another. In this case, when a periodic external force is applied to the fuel cell case 300, it is highly likely that any of the elastic members 320 resonates with the external force. Thus, the oscillation of the DMFC 10 can be made to last for a longer period of time.

In the present embodiment, the fuel cartridge 50 is attached to the DMFC 10. Thus, piping connecting the fuel cartridge 50 to the methanol fuel storage portion 26 of the DMFC 10 is not required. Therefore, leak of methanol solution caused by damage of the piping connecting the fuel cartridge 50 to the methanol fuel storage portion 26 because of the oscillation of the DMFC 10 can be eliminated.

### Fourth Embodiment

The basic structure of the fuel cell case 300 of a fourth embodiment is the same as that of the third embodiment. In the description of the fourth embodiment, the description of the same part as that in the third embodiment will be omitted in an appropriate manner.

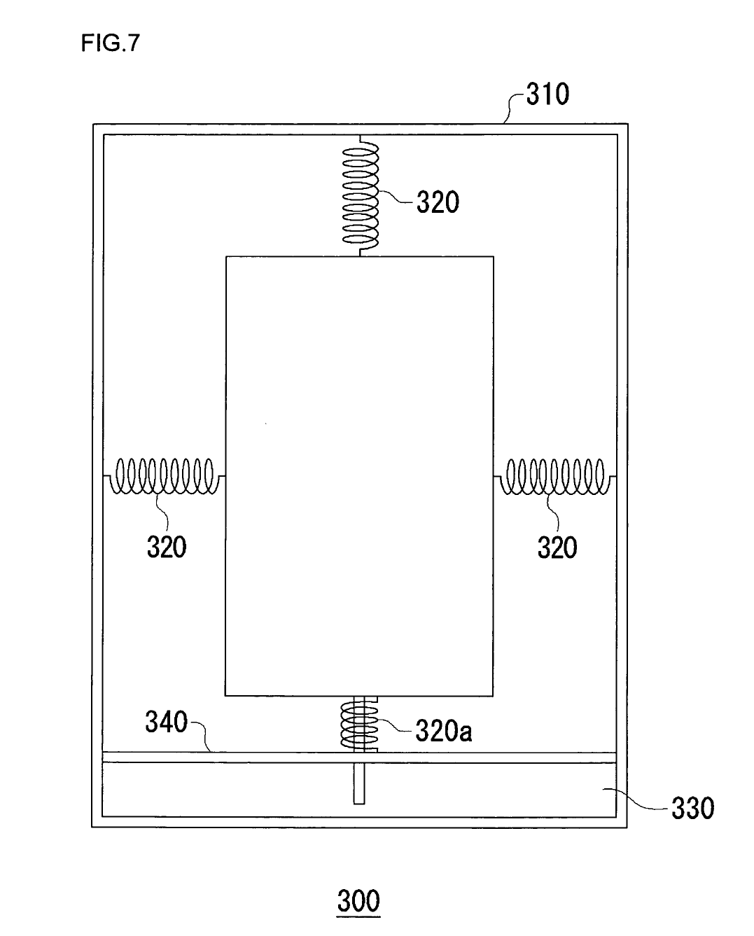

FIG. 7 is a cross-sectional view showing the structure of the fuel cell case 300 according to the fourth embodiment. In the present embodiment, a fuel storage portion 330 formed by sealing a part of the inside of the housing 310 is provided in place of the fuel cartridge 50 in the third embodiment. More specifically, an inner space of the housing 310 is divided by a partition member 340 so as to form the fuel storage portion 330. In this case, a surface of the partition member 340 on the DMFC 10 side serves as an inner surface of the fuel cell case 300. In the present embodiment, the surface of the partition member 340 on the DMFC 10 side is connected to an outer surface of the DMFC 10 that is opposed thereto by the elastic member 320a. In this case, it is preferable that the partition member 340 have rigidity.

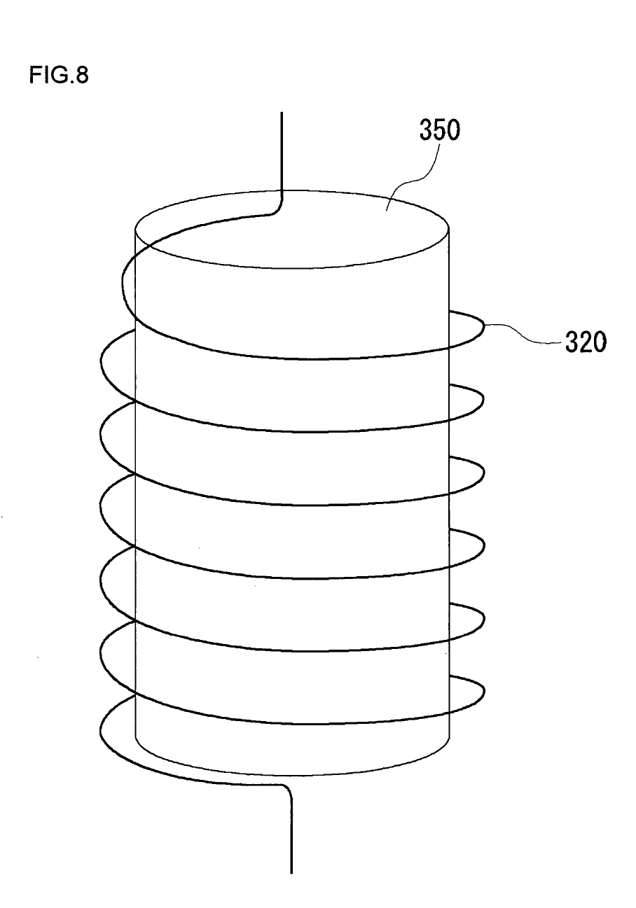

A fuel replenishment member 350 extends through the partition member 340 and connects the methanol fuel storage portion 26 and a space in the inside of the fuel storage portion 330 to each other. In the present embodiment, the fuel replenishment member 350 is assembled with the elastic member 320 attached to the partition member 340. More specifically, as shown in FIG. 8, the fuel replenishment member 350 is arranged inside a coil of a coil spring serving as the elastic member 320. Due to this structure, a load applied to the fuel replenishment member 350 and the elastic member 320 assembled with the fuel replenishment member 350 is distributed, thus enhancing strength of connection between the fuel cell case 300 and the DMFC 10. Although FIG. 8 shows a single fuel replenishment member 350 as an example, a plurality of fuel replenishment members 350 may be arranged inside the coil of the coil spring.

The fuel replenishment member 350 can be formed from a material that has flexibility and can suck methanol solution, e.g., polyester.

Due to this, it is possible to store methanol solution in the fuel storage portion 330 formed by using the inner space of the fuel cell case 300. Moreover, methanol solution is sucked by the fuel replenishment member 350 from a portion thereof that is soaked in methanol solution in the fuel storage portion 330, and is gradually replenished in the methanol fuel storage portion 26.

In the present embodiment, the fuel storage portion 330 is provided in a lower part in the fuel cell case 300. Alternatively, the fuel storage portion 330 may be formed in an upper part or a side part in the fuel cell case 300. Moreover, the fuel storage portion 330 may be provided at each of a plurality of positions in the fuel cell case 300. It is preferable to arrange the fuel storage portions 330 in the fuel cell case 300 in such a manner that the fuel replenishment member 350 is soaked in methanol solution in any of the fuel storage portions 330 even when the fuel cell case 300 turns around. Due to this, it is possible to surely replenish methanol solution in the methanol fuel storage portion 26 irrespective of an orientation of the fuel cell case 300.

### Fifth Embodiment

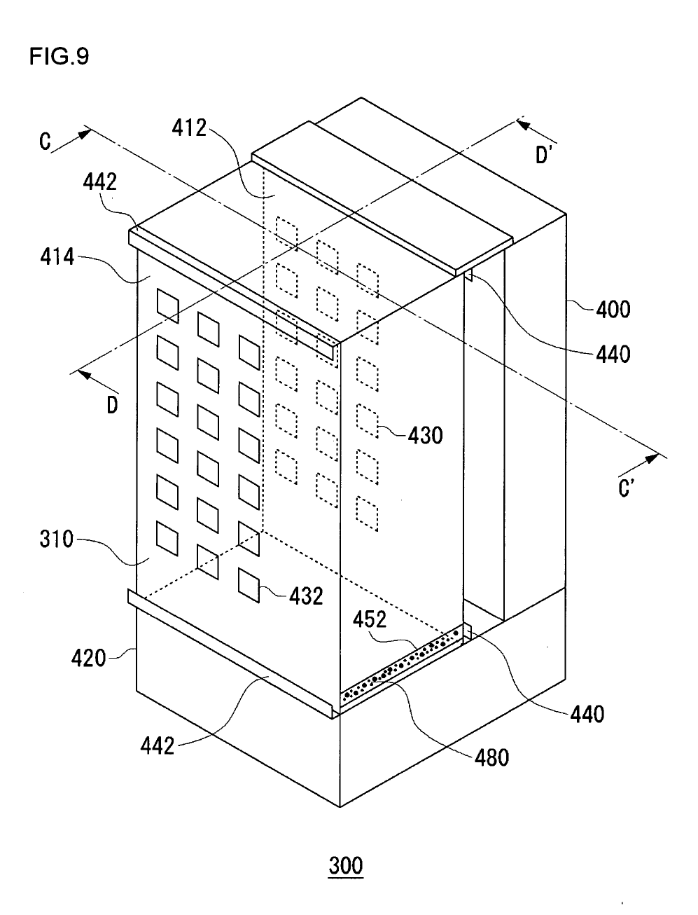

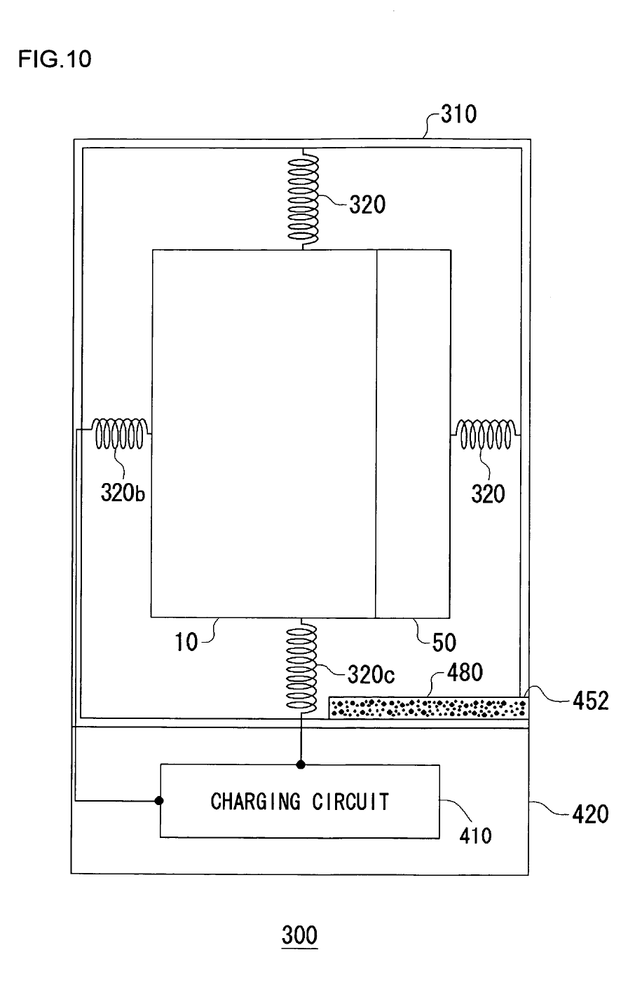

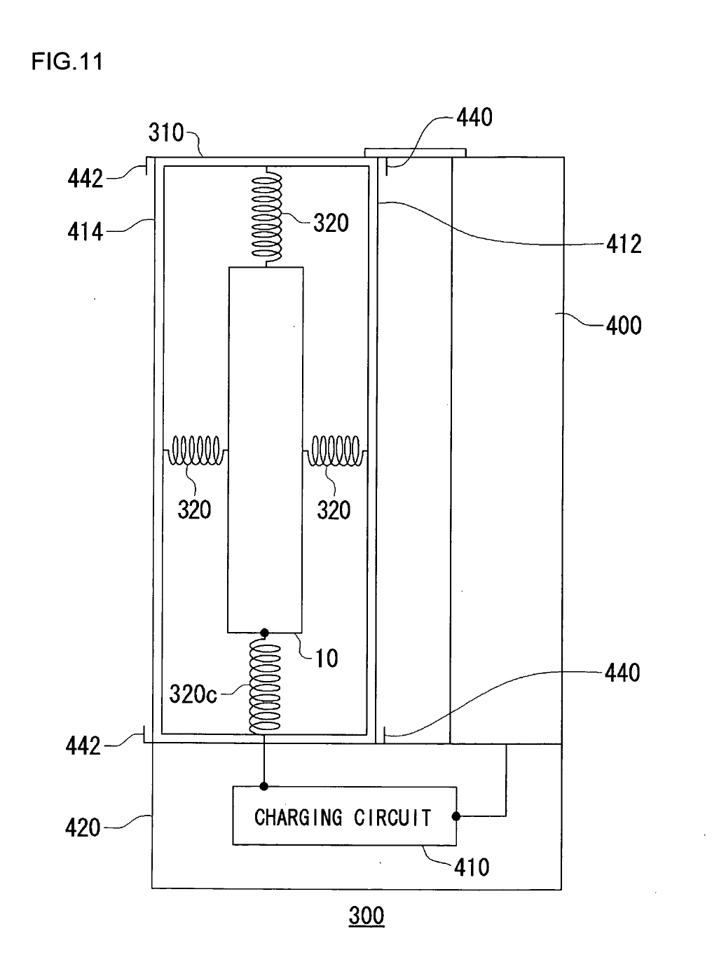

FIG. 9 is a perspective view showing the structure of a fuel cell case 300 according to a fifth embodiment. FIGS. 10 and 11 are cross-sectional views of the fuel cell case 300, taken along the lines C-C′ and D-D′ in FIG. 9, respectively.

The fuel cell case 300 of the fifth embodiment includes the structure in the third embodiment, a lithium secondary battery 400, and a charging circuit 410.

The lithium secondary battery 400 is charged with power generated by the DMFC 10. The lithium secondary battery 400 is mounted on a base portion 420 on which the housing 310 is mounted, so as to be away from the housing 310. In the present embodiment, the housing 310 and the lithium secondary battery 400 are arranged in such a manner that a surface 412 of the housing 310 that is opposed to the anode side of the DMFC 10 faces the lithium secondary battery 400 and a surface 414 of the housing 310 that is opposed to the cathode side of the DMFC 10 is opposite to the lithium secondary battery 400. The surfaces 412 and 414 of the housing 310 have openings 430 and 432, respectively. Due to this, it is possible to take an air into the cathode side of the DMFC 10 from the outside of the fuel cell case 300 and discharge carbon dioxide generated by electrochemical reaction to the outside of the fuel cell case 300 from the anode side of the DMFC 10.

In the present embodiment, a water-absorbing member 480 is provided in a lower part of the housing 310. The water-absorbing member 480 can be taken in and out through a slot 462 provided in the housing 310. In the case where water generated in the DMFC 10 falls into a lower part of the housing 310, the water-absorbing member 480 absorbs and retains the water. Thus, it is possible to suppress splashing of the water staying in the housing 310. When a water-absorbing capacity of the water-absorbing member 480 is lowered, the water-absorbing member 480 can be taken out and changed.

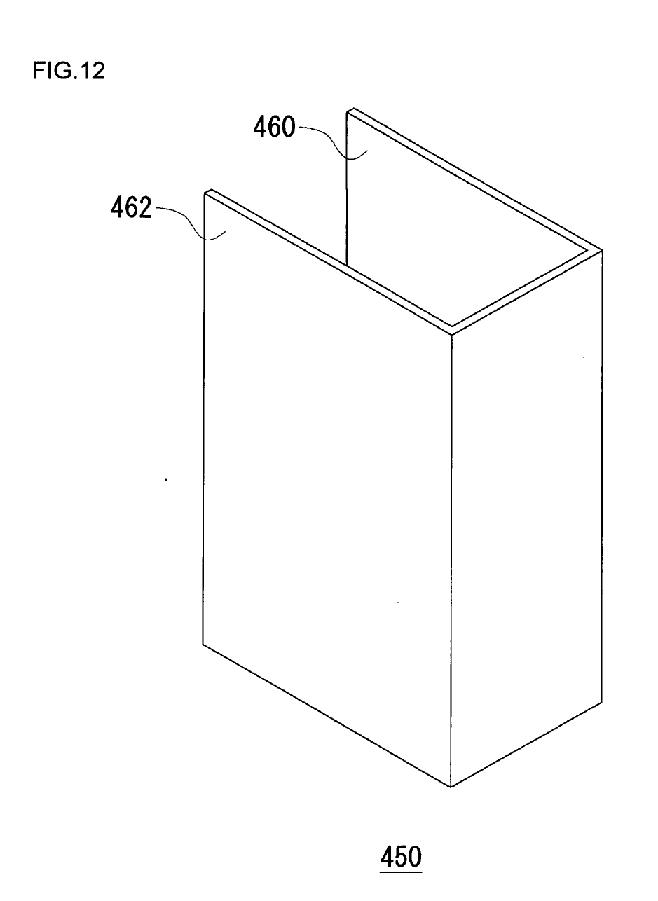

Rails 440 and 442 are provided on the surfaces 412 and 414 of the housing 310, respectively. A shutter 450 shown in FIG. 12 can be inserted into and drawn out from the rails 440 and 442. The shutter 450 has a plate 460 that slides along the rails 440 and a plate 462 that slides along the rails 442. While the shutter 450 is drawn out, an inside and an outside of the housing 310 are in communication with each other through the openings 430 and 432. The openings 430 and 432 can be closed by sliding the shutter 450 and inserting it into the rails 440 and 442. Due to this structure, entering of an air into the fuel cell case 300 is suppressed while the DMFC 10 is not used. Therefore, electrochemical reaction in the DMFC 10 can be rapidly stopped.

The charging circuit 410 is included in the base portion 420 on which the housing 310 is mounted. The power generated by the DMFC 10 is supplied to the lithium secondary battery 400 by the charging circuit 410, after being converted into a predetermined voltage.

The charging circuit 410 is electrically connected to the anode and the cathode of the DMFC 10 by elastic members 320b and 320c having electrical conductivity. Thus, the DMFC 10 and the charging circuit 410 can be electrically connected to each other without increasing the number of parts. Therefore, a manufacturing cost of the fuel cell case 300 can be reduced.

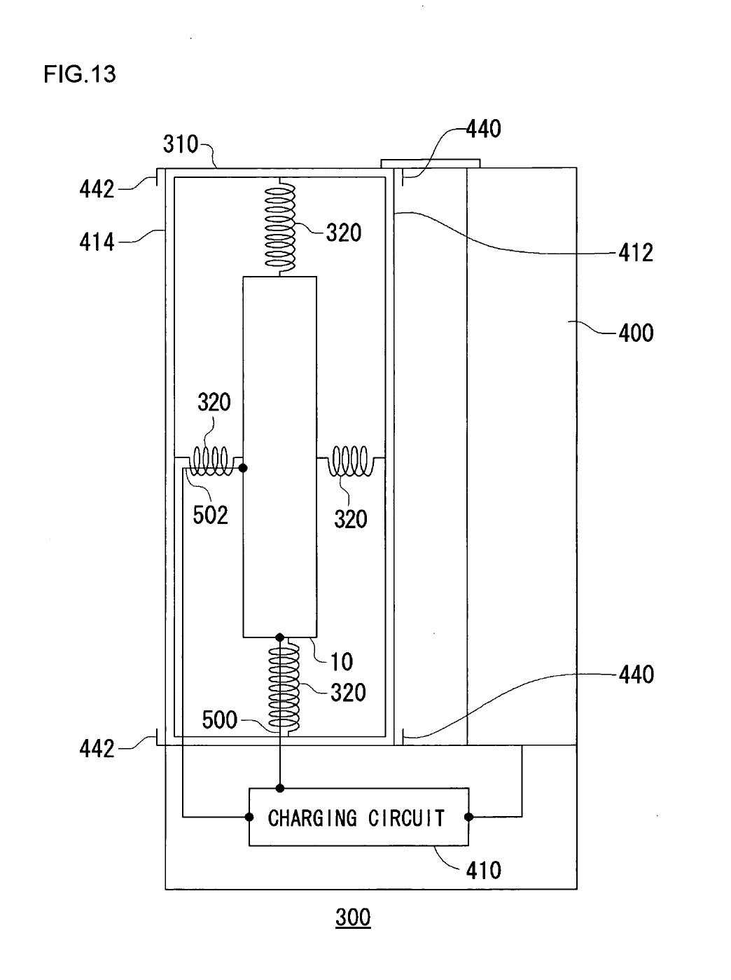

In the present embodiment, the elastic member 320 also serves as a conductor that electrically connects the DMFC 10 to the charging circuit 410. However, a method for electrically connecting the DMFC 10 and the charging circuit 410 to each other is not limited thereto. For example, as shown in FIG. 13, each of a conductor 500 connected to the anode of the DMFC 10 and a conductor 502 connected to the cathode of the DMFC 10 is arranged inside a coil of a coil spring used as the elastic member 320. In this case, it is desirable that each of the conductors 500 and 502 have a sufficient length that can respond to expansion and contraction of the elastic member 320. Due to this structure, the elastic members 320 do not strike against the conductors 500 and 502 even if the elastic members 320 vibrate or roll. Thus, occurrence of damage in the conductors 500 and 502 and the elastic members 320 can be suppressed, resulting in a long operating life of the fuel cell case 300. Moreover, when the conductors 500 and 502 are electrically insulated from each other, the conductors 500 and 502 can be arranged inside a coil of a coil spring forming a single elastic member 320.

It should be noted that an appropriate combination of the above components could be encompassed within the scope of the invention to be protected by a patent that is requested by the present application.

For example, a surface of the partition member 340 on the DMFC 10 side is connected to an outer surface of the DMFC 10 opposed thereto by the elastic member 320a in the fuel cell case 300 of the fourth embodiment. However, the present invention is not limited thereto. Alternatively, the elastic member 320a may extend through the partition member 340 so as to be connected to an original inner surface of the housing 310 that is opposed to the outer surface of the DMFC 10, for example. In this case, it is preferable that the partition member 340 be flexible.

Moreover, the shutter 450 of the fifth embodiment may have an opening 470 provided in the plate 460 to correspond to the opening 430 and have an opening 472 provided in the plate 462 to correspond to the opening 432. In this case, an interval of the openings 430 adjacent to each other in an extending direction of the rails 440 is set to be equal to or larger than a width of the opening 430 in the extending direction of the rails 440, and an interval of the openings 432 adjacent to each other in an extending direction of the rails 442 is set to be equal to or larger than a width of the opening 432 in the extending direction of the rails 442 (see FIG. 9). Due to this, it is not necessary to completely insert and draw out the shutter 450 in order to open and close the openings 430 and 432. Thus, a moving distance of the shutter 450 can be made necessity minimum.

In the fifth embodiment, the openings 430 and 432 can be opened and closed with the slidable shutter. However, means that opens and closes the openings 430 and 432 is not limited thereto. For example, the openings 430 and 432 may be opened and closed with a cover that can be opened and closed with a hinge.

The present invention can be applied to any type of a fuel cell to which a liquid fuel, that is not limited to methanol, is directly supplied.

What is claimed is:

1. A direct liquid fuel cell comprising:
an electrolyte membrane;
an anode electrode provided on a surface of the electrolyte membrane;
a cathode electrode provided on another surface of the electrolyte membrane; and
a liquid fuel storage portion provided to be adjacent to the anode electrode, the storage portion supplying a liquid fuel to the anode electrode, wherein
the liquid fuel storage portion contains a solid particle.

2. The direct liquid fuel cell according to claim 1, wherein
the solid particle is formed from a material that is hardly soluble with respect to the liquid fuel.

3. The direct liquid fuel cell according to claim 1, wherein
the solid particle contains a plurality of types of solid particles having different shapes.

4. The direct liquid fuel cell according to claim 1, wherein
the solid particle contains a plurality of types of solid particles having different densities.

5. The direct liquid fuel cell according to claim 1, wherein
a surface in which the gas generated by the anode electrode stays is not horizontal.

6. A fuel cell case comprising:
a direct liquid fuel cell including an electrolyte membrane, an anode electrode provided on a surface of the electrolyte membrane, a cathode electrode provided on another surface of the electrolyte membrane, and a liquid fuel storage portion that is provided to be adjacent to the anode electrode and supplies a liquid fuel to the anode electrode;
a fuel keeping portion which stores a liquid fuel with which the liquid fuel storage portion is refilled;
a housing which accommodates the fuel cell and the fuel keeping portion; and
at least one elastic member which connects at least one outer surface of the fuel cell to an inner surface of the housing that is opposed to the outer surface of the fuel cell.

7. The fuel cell case according to claim 6, wherein:
at least a pair of outer surfaces of the fuel cell are connected to inner surfaces of the housing that are opposed to the respective outer surfaces by a plurality of the elastic members; and
at least two of the plurality of elastic members has natural frequencies different from each other.

8. The fuel cell case according to claim 6, wherein:
a plurality of outer surfaces of the fuel cell are connected to inner surfaces of the housing that are opposed to the respective outer surfaces of the fuel cell by elastic members, respectively; and
elastic members for at least two of a plurality of pairs of an outer surface of the fuel cell and an inner surface of the housing have natural frequencies different from each other.

9. The fuel cell case according to claim 6, wherein
the fuel keeping portion is attached to the fuel cell.

10. The fuel cell case according to claim 6, further comprising a fuel replenishment member which connects the fuel keeping portion and the liquid fuel storage portion to each other, the fuel replenishment member sucking the liquid fuel stored in the fuel keeping portion, and supplying the sucked liquid fuel to the liquid fuel storage portion, and
wherein the fuel keeping portion is formed by sealing a part of an inside of the housing.

11. The fuel cell case according to claim 10, wherein:
the inner surface of the housing to which the elastic member is connected is a surface of a member forming the fuel keeping portion; and
the fuel replenishment member is assembled with the elastic member.

12. The fuel cell case according to claim 6, further comprising:
a charging portion which charges with power generated by the fuel cell; and
a charging circuit which supplies the power from the fuel cell to the charging portion.

13. The fuel cell case according to claim 12, further comprising a base portion on which the housing and the charging portion are mounted, and wherein:
openings are provided in a cathode-side surface of the housing that is opposed to a cathode side of the fuel cell and in an anode-side surface of the housing that is opposed to an anode side of the fuel cell; and
the charging portion is provided on the base portion to be away from the anode-side surface.

14. The fuel cell case according to claim 12, wherein
at least one of the elastic members is a conductor which electrically connects the fuel cell to the charging circuit.

15. The fuel cell case according to claim 12, wherein:
at least one of the elastic members is a coil spring; and
the conductor which electrically connects the fuel cell to the charging circuit is arranged inside a coil of the coil spring.

16. The fuel cell case according to claim 12, further comprising an opening and closing portion capable of opening and closing an opening provided in the anode-side surface and/or an opening provided on the cathode-side surface.

17. The fuel cell case according to claim 6, wherein
the liquid storage portion contains a solid particle.

18. The fuel cell case according to claim 17, wherein
the solid particle is formed from a material that is hardly soluble with respect to the liquid fuel.

19. The fuel cell case according to claim 17, wherein
the solid particle contains a plurality of types of solid particles having different shapes.

20. The fuel cell case according to claim 17, wherein
the solid particle contains a plurality of types of solid particles having different densities.
